(19) United States
(12) Patent Application Publication
(10) Pub. No.: US 2003/0161374 A1
(43) Pub. Date: Aug. 28, 2003

(54) High-resolution confocal Fabry-Perot interferometer for absolute spectral parameter detection of excimer laser used in lithography applications

(75) Inventor: Peter Lokai, Goettingen (DE)

Correspondence Address: STALLMAN & POLLOCK LLP, Attn: Brian J. Keating, 121 Spear Street, Suite 290, San Francisco, CA, 94105, US

(73) Assignee: Lambda Physik AG

(21) Appl. No.: 10/293,906

(22) Filed: Nov. 12, 2002

Related U.S. Application Data
(60) Provisional application No. 60/332,573, filed on Nov. 21, 2001.

(51) Int. Cl. H01S 3/22; H01S 3/223

(52) U.S. Cl. 372/57

(57) ABSTRACT

A spectrometer based on a high-resolution confocal Fabry-Perot interferometer for detection of wavelength, FWHM and/or 95% bandwidth of a laser beam of a narrow band tunable excimer or molecular fluorine lithography laser, or EUV generating source, preferably includes a reduction telescope for reducing the laser beam, a diffusor to homogenize the incident excimer or molecular fluorine lithography laser beam, a housing for mounting the confocal Fabry-Perot interferometer between windows in a sealed and temperature-stabilized housing, imaging optics for bringing the incident beam to focus at approximately a center of the interferometer, interferometer fringe imaging optics, and a photoelectric detector of the interferometer fringe image.

### PRIORITY

This application claims the benefit of priority to U.S. provisional patent application serial No. 60/332,573, filed Nov. 21, 2001.

### BACKGROUND OF THE INVENTION

1. Field of the Invention

The invention relates to laser spectrometry, and particularly to an apparatus and method for improving the resolution of a spectrometer for measuring parameters of a laser beam.

2. Discussion of the Related Art

Semiconductor manufacturers are currently using deep ultraviolet (DUV) lithography tools based on KrF-excimer laser systems operating around 248 nm, as well as the following generation of ArF-excimer laser systems operating around 193 nm. The F₂-laser operating around 157 nm is being developed for use with Vacuum UV (VUV) photolithography. Higher energy, higher stability, and higher efficiency excimer and molecular fluorine lasers are being developed as lithographic exposure tools for producing very small structures as chip manufacturing proceeds into the 0.10 micron regime and beyond. Specific characteristics of laser systems sought to be improved upon particularly for the lithography market include higher repetition rates, increased energy stability and dose control, increased percentage of system uptime, narrower output emission bandwidths, improved wavelength and bandwidth accuracy, and improved compatibility with stepper/scanner imaging systems.

It is recognized herein that various components and tasks relating to today's lithography laser systems may be advantageously designed to be computer- or processor-controlled. The processors may be programmed to receive various inputs from components within the laser system, and to signal those components and/or other components to perform adjustments such as gas mixture replenishment, discharge voltage control, burst control, alignment of resonator optics for energy, linewidth or wavelength adjustments, among others, in feedback arrangements.

It is important for their respective applications to the field of sub-quarter micron silicon processing that each of the above laser systems become capable of emitting a narrow spectral band of known bandwidth and around a very precisely determined and finely adjustable absolute wavelength. Techniques for reducing bandwidths by special resonator designs to less than 100 pm for use with all-reflective optical imaging systems, and for catadioptric imaging systems to less than 0.6 pm, are being continuously improved upon. Depending on the laser application and imaging system for which the laser is to be used, line-selection and/or line-narrowing techniques are described at U.S. patent application Ser. Nos. 09/317,695, 09/244,554, 09/452,353, 09/602,184, 09/599,130 and 09/629,256, each of which is assigned to the same assignee as the present application, and U.S. Pat. Nos. 5,761,236, 6,081,542, 6,061,382, 5,946,337, 6,285,701, 6,154,470, 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, and 4,829,536, all of which are hereby incorporated by reference. Some of the line selection and/or line narrowing techniques set forth in these patents and patent applications may be used in combination.

Techniques are also available for tuning and controlling central wavelengths of emission. Absolute wavelength calibration techniques use a known absorption, emission or level-transition line around the wavelength of interest as a reference (see U.S. Pat. Nos. 4,905,243, 4,926,428, 5,450,207, 5,373,515, 5,978,391, 5,978,394, 6,160,832 and 4,823,354, and F. Babin et al., Opt. Lett., v. 12, p. 486 (1987), and R. B. Green et al., Appl. Phys. Lett., v. 29, p. 727 (1976), as well as U.S. patent applications Ser. Nos. 09/416,344 and 09/791,431 (each application being assigned to the same assignee as the present application), all of the above being hereby incorporated by reference).

The '243 patent, also mentioned above, describes the use of a monitor Fabry-Perot etalon to determine relative wavelength shifts away from the known Fe absorption lines, e.g., at 248.3271 nm and 248.4185 nm, among others. To do this, the laser wavelength is first calibrated to the absolute wavelength reference line, e.g., 248.3271 nm, and the laser beam is directed through the etalon. An interferometric image is projected onto a solid state image detector such as a CCD array. Next, the laser wavelength is tuned away from the 248.3271 nm line to a new wavelength. A new image is projected onto the detector, and a comparison with the original image reveals the new wavelength because the free spectral range (FSR) of the monitor etalon is presumably known (e.g., 9.25 pm). For example, if it is desired to tune the laser to 248.3641 nm, then the wavelength would be adjusted 37 pm above the 248.3271 nm Fe vapor absorption line to exactly coincide with four FSRs of the monitor etalon.

Other optical characteristics of a laser beam that are desired to know and control are the bandwidth and spectral purity. The bandwidth can be measured as the full width at half maximum (FWHM) of a spectral intensity distribution of a measured laser pulse. The spectral purity is determined as the spectral range within which lies 95% of the energy of the laser pulse.

The bandwidth of a radiation source used, e.g., in photolithographic applications, is constrained by its effect on imaging resolution due to chromatic aberrations in optics of catadioptric imaging systems. The bandwidth of a laser beam can be determined from measuring the widths of fringes produced as the laser beam is passed through a monitor etalon and projected onto a CCD array. A grating spectrometer may also be used and the bandwidth measured in a similar fashion (see U.S. Pat. Nos. 5,081,635 and 4,975,919, each of which is hereby incorporated by reference). It is desired, however, to have a technique for more precisely determining spectral information such as the bandwidth, spectral purity and/or wavelength of a laser beam.

Narrow band excimer lasers (ArF emitting around 193 nm, KrF emitting around 248 nm, and F₂ Lasers emitting around 157 nm) are used in the semiconductor industry in the production of the integrated circuits to make structure below 0.25 microns according to a process known as microlithography. To keep imaging errors caused by chromatic aberration below tolerance, radiation of narrow bandwidth in the range <0.4 pm (FWHM) is typically used, particularly when the imaging system includes refractive optics made of a single material. Another important parameter is the spectral purity or the bandwidth which contains 95% of the output pulse energy. New high numerical aperture (NA) imaging optics used in the photolithography utilize exposure radiation bandwidths <1 pm.

Microlithography lasers typically use plane/plane air-spaced Fabry-Perot etalons or grating/etalon monochromators for monitoring spectral information of the output beam. The finesse of such systems is limited and more precise detection of FWHM bandwidth and mainly 95% bandwidth for excimer lasers with narrower spectral parameters is desired.

Use of double or triple pass, double or triple plane/plane Fabry-Perot etalons can be used to improve the resolution. The second or third etalon in this configuration should be perfectly matched to the first double pass etalon. However, this matching procedure is complicated.

### SUMMARY OF THE INVENTION

In view of the above, an excimer or molecular fluorine laser system is provided including a discharge chamber filled with a gas mixture at least including molecular fluorine and a buffer gas, a pulsed electrical discharge circuit, multiple electrodes within the discharge chamber connected to the discharge circuit for energizing the gas mixture, a resonator including the discharge chamber and a line-narrowing and/or selection module for generating a narrow band laser beam, and a spectrometer including a confocal Fabry-Perot interferometric device for monitoring one or more spectral parameters of the laser beam with high precision.

The spectrometer based on a high-resolution confocal Fabry-Perot interferometer preferably detects wavelength, FWHM and/or 95% bandwidth of a laser beam of a narrow band tunable excimer or molecular fluorine lithography laser. The spectrometer preferably includes one or more of: a reduction telescope for reducing the laser beam, a diffusor to homogenize the incident excimer or molecular fluorine lithography laser beam, a confocal Fabry-Perot interferometer between windows in a sealed and temperature-stabilized housing, the beam entering and exiting the housing and interacting with the interferometer through the windows of the housing, imaging optics for bringing the incident beam to focus at approximately a center of the interferometer, interferometer fringe imaging optics, and/or a photoelectric detector of the interferometer fringe image.

The reduction of the reduction telescope may be preferably at least substantially three times. The interferometer housing may be vacuum sealed. A processor may receive spectrometric signals from the spectrometer and initiating adjustments of one or more optical components in feedback loop for wavelength stabilization of the lithography laser beam.

The interferometer may include a fixed interferometer spacer comprising a thermally-stable material. The material being selected from the group consisting of Zeodur, Cer Vit, and ULI. The interferometer may include a piezoelectric spacer that can be tuned for operation of the interferometer in scanning mode.

The photoelectric detector may include a detector array. The detector array being a linear photodetector array. The confocal Fabry-Perot interferometer may be mounted within a housing, and the pressure inside of the housing may be adjustable for operation in scanning mode. The photoelectric detector comprising a diaphragm. The diaphragm may be an iris. The photodetector may include a single photodiode.

### BRIEF DESCRIPTION OF THE DRAWINGS

FIG. 1a schematically shows a first preferred embodiment of an excimer or molecular fluorine laser system.

FIG. 1b schematically shows a galvatron for absolute wavelength calibration.

FIG. 1c schematically shows a second preferred embodiment of an excimer or molecular fluorine laser system.

FIG. 2 schematically illustrates a ray path in a confocal Fabry-Perot interferometer according to a preferred embodiment.

FIG. 3 schematically illustrates detection of spectral parameters using a confocal Fabry-Perot Interferometer according to a preferred embodiment.

### INCORPORATION BY REFERENCE

What follows is a cite list of references which are, in addition to any references cited above in the background section or below in the detailed description of the preferred embodiments, and the background section itself, and the summary of the invention, hereby incorporated by reference into the detailed description of the preferred embodiments below, as disclosing alternative embodiments of elements or features of the preferred embodiments not otherwise set forth in detail below. A single one or a combination of two or more of these references may be consulted to obtain a variation of the preferred embodiments described in the detailed description below. Further patent, patent application and non-patent references are cited in the written description and are also incorporated by reference into the preferred embodiment with the same effect as just described with respect to the following references:

U.S. Pat. Nos. 6,424,666, 6,389,052, 6,298,080, 6,381,256, 6,243,406, 6,421,365, 6,243,170 B1, 5,081,635, 4,975,919, 4,905,243, 4,926,428, 5,450,207, 5,373,515, 5,978,391, 5,978,394, 6,061,382, 6,345,065, 6,285,701, 6,272,158, 6,327,284, 6,330,267, 6,393,037, 6,414,828, 6,426,966, 6,327,290, 6,160,832, 6,160,831, 6,269,110, and 4,823,354;

F. Babin et al., Opt. Lett., v. 12, p. 486 (1987);

R. B. Green et al., Appl. Phys. Lett., v. 29, p. 727 (1976);

U.S. patent application Ser. Nos. 09/769,019, 09/791,496, 09/774,238, 09/771,366, 09/738,849, 09/686,483, 09/688,561, 09/718,803, 60/280,398, 09/718,809, 09/712,367, 09/771,013, 09/780,124, 09/780,120, 09/791,431, 09/811,354, 09/903,425, 09/843,604, 09/883,127, 09/883,128, 09/900,703, 09/923,770, 09/960,875, 10/001,954, 10/035,351, 10/036,848, 10/112,660, 10/112,070, 60/278,279, 60/305,368, 60/309,939, 09/598,552, 09/574,921, 09/640,595, 09/513,025, 09/741,465, 09/712,877, 09/453,670, 09/602,184, 09/512,417, 09/416,344, 60/317,766, 60/305,368, 60/278,279, 60/332,573, 60/358,291, 60/375,695, 60/407,096, 60/419,176, 60/381,586, 60/375,695, 60/358,291, 60/325,387, 10/112,660, 09/903,425, 60/325,387, 09/811,354, 60/280,398, 09/715,803, 09/975,091, 09/791,496, 09/686,483 and 09/791,431, which are each assigned to the same assignee as the present application;

U.S. published application Ser. No. US2001/0013933 A1;

W. Demtröder Laser Spectroscopy, Springer, Berlin 1981

A. I. Ershow et al. Novel metrology for measuring spectral purity of KrF lasers for deep UV lithography, CYMER Tech Note

R. Sandstrom, “Argon Fluoride Excimer Laser Source for Sub-0.25 mm Optical Lithography,” Optical/Laser Microlithography IV, Vol. 1463, pp. 610-616, 1991;

P. Camus, “Atomic Spectroscopy with Optogalvanic Detection, Journal De Physique, (Paris) 11C7, pp. C7-87-106, November 1983;

Richard A. Keller et al., “Atlas for optogalvanic wavelength calibration,” Applied Optics, Vol. 19, No. 6, pp. 836-837, Mar. 15, 1980;

R. A. Keller et al., “Opto-galvanic spectroscopy in a uranium hollow cathode discharge,” J. Opt. Soc. Am., Vol. 69, No. 5, pp. 738-742, May 1979;

Norman J. Dovichi, et al., “Use of the optogalvanic effect and the uranium atlas for wavelength calibration of pulsed lasers,” Applied Optics, Vol. 21, No. 8, pp. 1468-1473, Apr. 15, 1982;

Masakatsu Okada et al., “Electronic Tuning of Dye Lasers by an Electroooptic Birefringent Fabry-Perot Etalon,” Optics Communications, Vol. 14, No. 1, pp. 4-7, 1975; and

### DETAILED DESCRIPTION OF THE PREFERRED EMBODIMENT

In view of the above, a confocal Fabry-Perot high resolution interferometer is provided for very precise detection of the spectral parameters, e.g., FWHM bandwidth and 95% energy bandwidth, of narrow band tunable excimer and molecular fluorine lasers. This interferometric monitoring device is compact and precise enough to determine directly either or both of these parameters with a desired precision for the next generation of microlithography lasers.

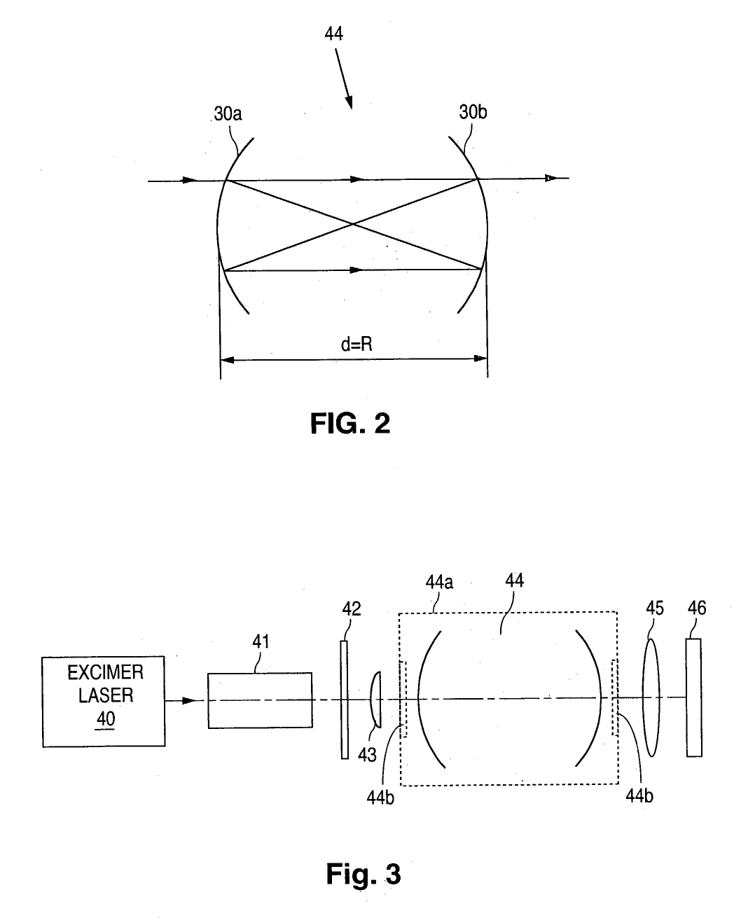

Preferably, one high resolution confocal Fabry-Perot interferometer is used, instead of one or more plane/plane Fabry-Perot etalons as described above, to monitor the spectral parameters of an excimer or molecular fluorine laser used in microlithography applications. The confocal Fabry-Perot interferometer uses two preferably spherical mirrors, whose spacing is chosen, as shown in FIG. 2 (see below), so that their foci coincide. The total finesse of the confocal Fabry-Perot interferometer is in general higher than that of a plane Fabry-Perot interferometer. The alignment of the spherical mirrors is advantageously less critical than that of plane mirrors. Moreover, spherical mirrors can be polished to a higher precision than plane mirrors. The light gathering power is also for high resolution confocal interferometric devices better than for plane etalons.

The confocal Fabry-Perot interferometer has a higher throughput than the plane F.P. interferometer and produces a uniform output field. It is therefore further a good candidate for operation in scanning mode by using piezoelectric spacers to vary the separation of the mirrors.

The production costs for one plane/plane Fabry-Perot etalon are lower than production costs for one Confocal Fabry Perot interferometric device. However, the resolution (FWHM and 95% BW) is with one plane/plane etalon limited (max effective finesse is=<40 and the 95% BW is limited to 1.2 pm) which is why the multiple pass arrangement with plane/plane etalons is used for very precise monitoring, while according to the present invention, a single confocal Fabry-Perot interferometric device may be used to obtain the desired precision, although more than one confocal Fabry-Perot (CFP) interferometric device may be used for still higher precision. The practical effective finesse of the CFP device can be higher than 100, and the instrument FWHM and 95% resolution (<0.5 pm) are for one pass better than for one plane/plane etalon. Using a multiple pass CFP device arrangement can further improve the resolution to a higher degree than the multiple plane etalon arrangement.

The preferred arrangement uses one high resolution confocal Fabry-Perot interferometer instead of multiple plane/plane Fabry-Perot etalons to achieve the desired high resolution. Such a compact bandwidth monitor improves and simplifies the detection of excimer and molecular fluorine laser spectral parameters. In addition, improvements can be also achieved using a multiple pass confocal Fabry-Perot interferometric device arrangement, either by passing the beam multiple times through a same device or by passing the beam through multiple devices.

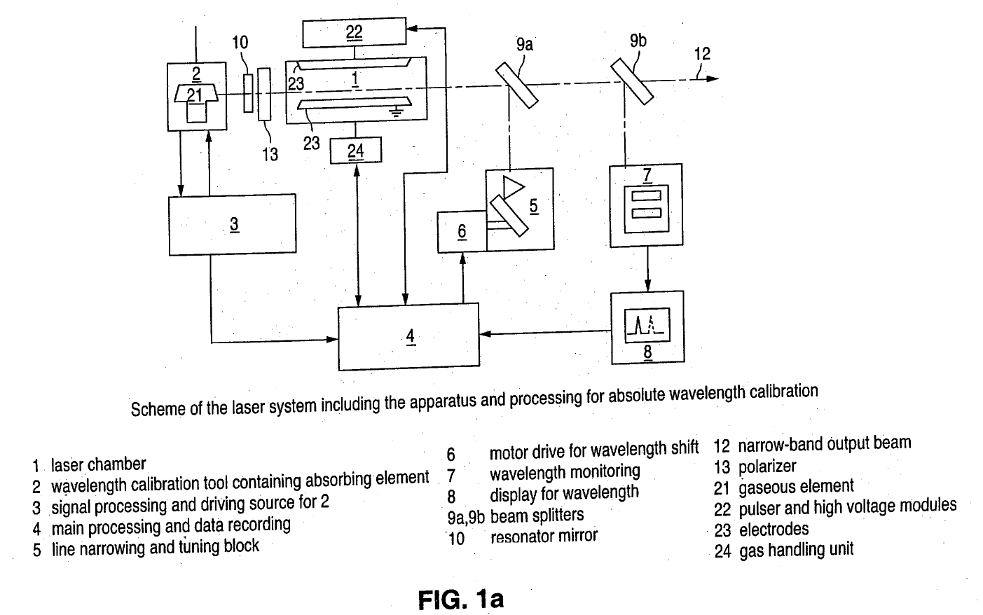

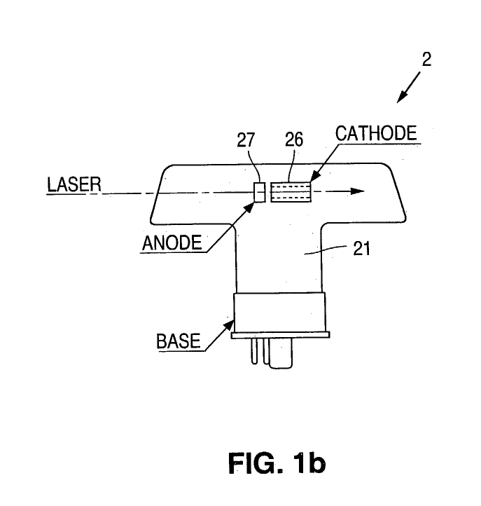

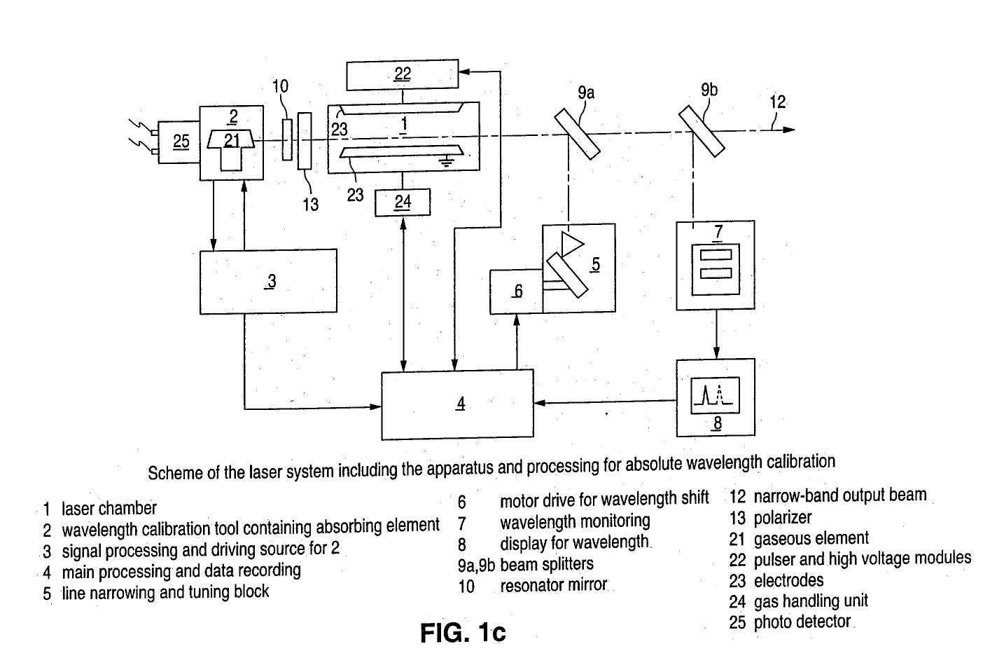

FIG. 1a schematically shows a first preferred embodiment of a laser system. A narrow band excimer or molecular fluorine laser system is the preferred laser system of FIG. 1a. The system includes a laser chamber 1 filled with a gas mixture and having a pair of main electrodes 23 and one or more preionization electrodes (not shown, but see U.S. patent applications Ser. Nos. 09/09/692,265, 09/863,931, 09/453,670 and 09/532,276, which are assigned to the same assignee as the present application and are hereby incorporated by reference). The electrodes 23 are connected to a solid-state pulser and high voltage module 22 (see, e.g., U.S. patent applications Ser. Nos. 09/858,147, 09/640,595 60/382,893 and 60/359,181, and U.S. Pat. Nos. 6,020,723, 6,226,307 and 6,005,880, which are each assigned to the same assignee as the present application and are hereby incorporated by reference).

A gas-handling module 24 is connected to the laser chamber 1 (see, e.g., U.S. patent applications Ser. Nos. 09/447,882 and 09/780,120, and U.S. Pat. No. 6,389,052, which are each assigned to the same assignee as the present application and are hereby incorporated by reference). A galvatron 21 is shown receiving a portion of the beam and communicating with a signal processing and driving source 3 (see, e.g., U.S. Pat. Nos. 6,160,832, 4,905,243 and 6,272,158, which are hereby incorporated by reference).

A laser resonator is shown including the laser chamber 1 including a resonator mirror 10, an optional polarizer 13, a beam splitter and a line-narrowing and tuning block or package 5. A motor drive controls the alignment of optics such as a grating, interferometric device and/or beam expander of the tuning block 5 for controlling the wavelength and/or bandwidth of the laser beam 12 (see, e.g., U.S. patent applications Ser. Nos. 09/712,367, and 09/584,420, and U.S. Pat. Nos. 6,426,966, 6,345,065, 6,424,666, and 6,421,365, which are each assigned to the same assignee as the present application and are hereby incorporated by reference). A wavefront compensating optic (not shown) may also be included (see, e.g., U.S. Pat. Nos. 6,061,382 and 6,285,701, and U.S. patent application Ser. No. 09/960,875, which are assigned to the same assignee as the present application and are hereby incorporated by reference). A second beam splitter 9b is shown reflecting a portion of the beam 12 to a wavemeter which is preferably a monitor confocal Fabry-Perot (CFP) interferomtric device 7 and an image from the CFP device is projected onto a CCD array detector or display 8.

A processor 4 controls various aspects of the laser system. One of the beam splitters 9a, 9b, or an additional beam splitter (not shown) preferably splits a beam portion which is directed to an energy monitor of an energy control feedback loop (see U.S. patent application Ser. No. 09/688,561, which is assigned to the same assignee as the present application and is hereby incorporated by reference).

The monitor CFP device 7 is used for performing relative wavelength calibration, whereby a wavelength of a laser beam may be tuned or shifted by a known amount. A grating or double-pass etalon spectrometer may be alternatively used (see U.S. patent application Ser. No. 09/975,091, which is assigned to the same assignee as the present application and is hereby incorporated by reference). The CFP device 7 produces a fringe pattern that depends on the wavelength. The fringe pattern is monitored when the wavelength is tuned or shifted, and by knowing the free spectral range of the CFP device 7, the amount of wavelength shift is determined. Alternatively, the laser wavelength can be shifted a specific amount by tuning the laser and stopping the tuning when a predetermined number of free spectral ranges have been tuned through, such that it is known that the wavelength is the desired wavelength. The CFP device 7 is preferably calibrated to an absolute standard using the wavelength calibration tool 2. A problem arises with conventional systems wherein the resolution of the FWHM bandwidth and/or spectral purity is not precise enough, and the preferred embodiments described herein below advantageously solve that problem.

The gas mixture in the laser chamber 2 typically includes about 0.1% F₂, 1.0% Kr and 98.9% Ne for a KrF-laser, 0.1% F₂, 1.0% Kr and 98.9% Ne and/or He for an ArF laser, and 0.1% F₂ and 99.9% Ne and/or He for a F₂ laser (for more details on the preferred gas mixtures, see U.S. patent applications Ser. Nos. 09/447,882, 09/418,052, 09/688,561 09/416,344, 09/484,818, 60/309,939 and 09/513,025, and U.S. Pat. Nos. 4,393,505, 6,212,214, 6,157,162 and 4,977,573, each of which is assigned to the same assignee as the present application and is hereby incorporated by reference). The laser system may be another gas discharge laser such as a KrCl, XeCl or XeF excimer laser. A trace amount of a gas additive such as xenon, argon or krypton may be included (see the '025 application, mentioned above).

The gas mixture is preferably monitored and controlled using an expert system (see the '214 patent, mentioned above). One or more beam parameters indicative of the fluorine concentration in the gas mixture, which is subject to depletion, may be monitored, and the gas supply replenished accordingly (see the patents and applications mentioned above). The processor 4 preferably receives information from various modules of the laser system including information concerning the halogen concentration in the gas mixture and initiates gas replenishment action such as micro-halogen injections, mini and partial gas replacements, and pressure adjustments by communicating with the gas-handling module 24.

Although not shown, the gas-handling module 24 has a series of valves connected to gas containers external to the laser system. The gas-handling module 24 may also include an internal gas supply such as a halogen and/or xenon supply or generator (see the '025 application). A gas compartment (not shown) may be included in the gas handling module 24 for precise control of the micro halogen injections (see the '882 application, mentioned above, and U.S. Pat. No. 5,396,514, which is assigned to the same assignee as the present application and is hereby incorporated by reference

Preferred main electrodes 23 are described at U.S. patent application Ser. No. 09/453,670, which is assigned to the same assignee as the present application and is hereby incorporated by reference. Other electrode configurations are set forth at U.S. Pat. Nos. 5,729,565 and 4,860,300, each of which is assigned to the same assignee and is hereby incorporated by reference. Preferred preionization units are set forth at U.S. patent applications Ser. Nos. 09/692,265 and 09/247,887, each of which is assigned to the same assignee as the present application and is hereby incorporated by reference. The preferred solid state pulser module and the high voltage power supply 22 are set forth at U.S. Pat. Nos. 6,020,723 and 6,005,880, and U.S. patent applications Ser. Nos. 09/640,595 and 09/390,146, each of which is assigned to the same assignee as the present application and is hereby incorporated by reference into the present application.

The resonator includes optics for line-narrowing and/or line-selection and also preferably for further narrowing the selected line. Many variations are possible For this purpose, those shown in U.S. Pat. Nos. 4,399,540, 4,905,243, 5,226,050, 5,559,816, 5,659,419, 5,663,973, 5,761,236, 6,154,470 6,081,542, 6,061,382, and 5,946,337, and U.S. patent applications Ser. Nos. 09/317,695, 09/130,277, 09/244,554, 09/073,070, 09/452,353, 09/602,184, 09/629,256, 09/599,130, 60/170,342, 60/172,749, 60/178,620, 60/173,993, 60/166,277, 60/166,967, 60/167,835, 60/170,919, 60/186,096, each of which is assigned to the same assignee as the present application, and U.S. Pat. Nos. 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, and German patent DE 298 22 090.3, are each hereby incorporated by reference into the present application. Some of the line selection and/or line narrowing techniques set forth in these patents and patent applications may be used in combination.

The laser chamber 1 normally has tilted windows, e.g., at Brewster's angle or another angle such as, e.g., 5°.

The discussion of the preferred embodiment with respect to the KrF-excimer laser applies similarly throughout to the ArF and molecular fluorine (F₂) lasers, and when necessary, important differences will be described. The main differences for the purposes of the preferred embodiments is that the F₂-laser emits around 157 nm, and the ArF laser emits around 193 nm, and the KrF laser emits around 248 nm. Thus, the wavelength calibration system for the F₂-laser and the ArF laser will be sensitive to radiation around 157 nm and 193 nm, respectively, whereas that for the KrF-excimer laser system will be sensitive around 248 nm. Also, except where discussed with respect to wavelength calibration according to the present invention, species such as water vapor and oxygen that strongly photoabsorb around 157 nm will be substantially removed from the optical path of any 157 nm radiation, whereas such substantial removal may or may not be performed in the case of 193 nm radiation, and are not typically performed for the 248 nm radiation, although they may be. In addition, various species will interact differently with incident 248 nm, 193 nm and 157 nm radiation. Moreover, different optical materials may be used for the three different wavelengths. For example, CaF₂ is preferred at 157 and 193 nm, while fused silica and/or CaF₂ are preferred at 248 nm.

The absolute wavelength calibration module 2 contains or comprises an element 21 which has an energy level transition line or lines around 248 nm. An energy level transition line is a detected atomic or molecular transition between atomic, electronic or molecular energy states of an element 21. An optical transition is one caused, facilitated, or stimulated by interaction of the atom or molecule with a photon of light. Examples of interactions involving optical transitions include absorption, emission, Raman scattering, and stimulated emission.

The element 21 is preferably a gaseous vapor contained within a hollow cathode lamp 2. Vaporous species that may be used as the element 21 within the module 2 have lines around 248 nm. The preferred species is iron. Some of the species that may be used for ArF lasers include arsenic (193.696 nm), germanium (193.750 nm), carbon (193.0905 nm, and other lines), iron, platinum, cobalt, gaseous hydrocarbons, halogenized hydrocarbons and carbon-contaminated inert gases. In addition, oxygen may be used as the element 21 and has several optical transition lines within the broadband emission spectrum of the ArF-laser. For the F₂ laser, bromine, selenium, iron and/or silicon may be preferably used. Other species, in addition to those mentioned above, that have detectable level-transition lines within the laser emission spectrum may be used as the element 21 contained within the wavelength calibration module 2. Quasi-transparent crystals and liquids that exhibit transition lines around the laser line may also be used.

FIG. 1b shows a galvatron which is an example of a wavelength calibration module 2. The galvatron is preferably filled with a buffer gas and having a certain proportion of the photoabsorbing element therein. The galvatron may be purged with the element 21 in gaseous form. A laser beam portion may enter and/or exit the module through Brewster windows. A cathode 26 inside the galvatron may comprise the element 21 in solid form, and then release the element in gaseous form when a current is generated between the cathode 26 and its associated anode 27 inside the galvatron 2. Laser light from the laser chamber passes through the galvatron 2 causing an inter-level resonance of the gaseous species when the wavelength of the laser light corresponds to an inter-level transition energy of the element 21. A marked voltage change is detected between the cathode 26 and the anode 27 when the laser light is tuned to these particular wavelength(s). Therefore, when the beam has a wavelength that corresponds to an energy level transition of the gaseous species 21 within the galvatron 2, a voltage or impedance change is detected and the absolute wavelength of the narrowed band is then determinable.

The galvatron or other gas-filled module may be used in a different way as shown in FIG. 1c. FIG. 1c includes the setup of FIG. 1a and additionally includes a photodetector 25 arranged near the galvatron. In the system of FIG. 1c, the galvatron 2 serves as a module filled with the element 21 in gaseous form, as described above. In this embodiment, the gas filled cell may be other than a galvatron, and as such, when the term galvatron is used herein it is meant broadly to mean a cell having a photoabsorbing, or otherwise photointeractive, species therein (i.e., photoabsorbing around the wavelength of interest for the laser system being used). The gaseous element 21 may be caused to fill the galvatron by forming the cathode 26 of the galvatron out of the element 21 in solid form, and running a current between the anode 27 and the cathode 26 of sufficient amplitude to sublimate the element 21. Alternatively, the module may simply be filled with the selected gaseous species.

The voltage across the anode and cathode are not monitored in the system of FIG. 1c, as they are with the system of FIG. 1a (i.e., for the purpose of detecting energy level resonances in species of the element 21 induced by the incident light). Instead, the intensity of the light as it passes through the galvatron 2 or other gas-filled module 2 is detected. By so doing, absorption lines of the element 21 are detected when the detected intensity is reduced below that which is expected at the wavelengths corresponding to the absorption lines. Since the absolute wavelengths of photoabsorption are known for the element 21, the absolute wavelength of the laser light is determinable.

The wavelength of the laser light is determined from a knowledge of the energy band levels and transition probabilities of species of the gaseous element 21. That is, when the wavelength of the laser beam is tuned within the emission spectrum of the laser, the absolute wavelength of the beam is precisely determined each time it corresponds to an inter-level transition energy of the gaseous species 21 having a finite transition probability density. The absolute wavelengths of the transition level resonance modes are precisely and reliably known since they are determined by relative positions of adjacent or removed quantized energy states of the photo-absorbing element, and applicable transition-selection rules. The preferred confocal Fabry-Perot interferometer is calibrated to an absolute standard preferably using one of the above techniques, and alternatively may be a reference laser or other reference (see, e.g., U.S. Pat. Nos. 6,160,831, 5,373,515 and 5,198,872, which are hereby incorporated by reference).

FIG. 2 schematically illustrates a ray path within a confocal Fabry-Perot interferometer 44. As shown in FIG. 2, the confocal Fabry-Perot interferometer 44 includes a pair of reflectors 30a and 30b that are preferably spherically-shaped. The confocal Fabry-Perot interferometer 44 uses the two spherical mirrors, whose spacing is chosen, as shown in FIG. 2, so that their foci preferably coincide. Among the advantages of the confocal Fabry-Perot interferometer 44 for monitoring spectral parameters of the laser system are that the total finesse of the confocal Fabry-Perot interferometer 44 is in generally higher than that of a plane Fabry-Perot interferometer. The alignment of spherical mirrors is by less critical than that of plane mirrors. Spherical mirrors can be polished to a higher precision than plane mirrors. The light gathering power is for the preferred high resolution confocal device better than for a plane etalon. The confocal Fabry-Perot interferometer 44 has a higher throughput than the plane Fabry-Perot etalon and produces a uniform output field. It is, therefore, desirable for operation in scanning mode by using piezoelectric spacers to vary the separation of the mirrors. The interferometer 44 may alternatively include cylindrical, spherical, or aspherical plates, and may include a flat plate with a curved plate, e.g., as may be otherwise described at U.S. patent application Ser. No. 60/280,398, which is assigned to the same assignee as the present application and is hereby incorporated by reference).

FIG. 3 schematically illustrates detection of spectral parameters using a confocal Fabry-Perot Interferometer according to a preferred embodiment. Referring to FIG. 3, the preferred arrangement includes an excimer or molecular fluorine laser 40 for generating a DUV/VUV laser beam, and may be an EUV generating source, e.g., emitting around 11-15 nm, for use in an optical lithography system. Preferably reflective optics are generally used for the EUV system, and may be substituted for the refractive DUV/VUV optics shown in FIG. 3 according to Babinet's principle. The reduction telescope 41 reduces the output beam generated by the laser 40, preferably providing at least three times reduction. The laser beam diffusor and/or beam homogenizer 42 homogenizes the reduced beam. The same or an additional homogenizer 42 may be disposed before the reduction optics 41. Imaging optics 43 focus the beam preferably at or near a center of the interferometer 44.

The confocal Fabry-Perot interferometer 44 is preferably disposed in a vacuum sealed and/or inert-gas purged housing 44a including entry and exit windows 44b for the beam. The housing 44a is preferably thermally and/or pressure controlled (see, e.g., U.S. patent application Ser. No. 09/686,483, which is assigned to the same assignee and is hereby incorporated by reference). Interferometer fringe imaging optics 45 serve to imaging the fringe pattern of the confocal Fabry-Perot interferometer 44 onto detector 46. The photoelectric detector 46, which may be an array detector, or photodiode including a fixed or adjustable diaphragm or iris. The preferred arrangement for detection of spectral parameters, e.g., wavelength, FWHM Bandwidth and/or 95% bandwidth of a narrow band excimer or molecular fluorine laser used for microlithography application is thus provided at FIGS. 2 and 3.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A spectrometeter based on a high-resolution confocal Fabry-Perot interferometer for detection of FWHM and/or 95% bandwidth of a laser beam of a narrow band tunable excimer or molecular fluorine lithography laser, comprising:
a) reduction telescope for reducing the laser beam;
b) a diffusor to homogenize the incident excimer or molecular fluorine lithography laser beam;
c) a confocal Fabry-Perot interferometer between windows in a sealed and temperature-stabilized housing, the beam entering and exiting the housing and interacting with the interferometer through the windows of the housing;
d) imaging optics for bringing the incident beam to focus at approximately a center of the interferometer;
e) interferometer fringe imaging optics;
f) a photoelectric detector of the interferometer fringe image.

2. The spectrometer of claim 1, the reduction of the reduction telescope being at least substantially three times.

3. The spectrometer of claim 1, the interferometer housing being vacuum sealed.

4. The spectrometer of claim 1, the interferometer including a fixed interferometer spacer comprising a thermally-stable material.

5. The spectrometer of claim 4, the material being selected from the group consisting of ZEODUR, CerVit, and ULI.

6. The spectrometer of claim 4, further comprising a processor for receiving spectrometric signals from the spectrometer and initiating adjustments of one or more optical components in feedback loop for wavelength stabilization of the lithography laser beam.

7. The spectrometer of claim 1, the interferometer including a piezoelectric spacer that can be tuned for operation of the interferometer in scanning mode.

8. The spectrometer of claim 1, the photoelectric detector being a detector array.

9. The spectrometer of claim 8, the detector array being a linear photodetector array.

10. The spectrometer of claim 1, the confocal Fabry-Perot interferometer being mounted within the housing, the pressure inside of the housing being adjustable for operation in scanning mode.

11. The spectrometer of claim 10, the interferometer including a fixed interferometer spacer comprising a thermally-stable material.

12. The spectrometer of claim 11, the material being selected from the group consisting of ZEODUR, Cer Vit, and ULI.

13. The spectrometer of claim 10, the interferometer including a piezoelectric spacer that can be tuned for operation of the interferometer in scanning mode.

14. The spectrometer of claim 1, the photoelectric detector comprising a diaphragm.

15. The spectrometer of claim 14, the diaphragm being an iris.

16. The spectrometer of claim 14, the photodetector including a single photodiode.

17. The spectrometer of claim 14, further comprising a processor for receiving spectrometric signals from the spectrometer and initiating adjustments of one or more optical components in feedback loop for wavelength stabilization of the lithography laser beam.

18. The spectrometer of claim 1, further comprising a processor for receiving spectrometric signals from the spectrometer and initiating adjustments of one or more optical components in feedback loop for wavelength stabilization of the lithography laser beam.

19. An excimer or molecular fluorine laser system, comprising:
a discharge chamber filled with a gas mixture at least including molecular fluorine and a buffer gas;
a pulsed electrical discharge circuit;
a plurality of electrodes within the discharge chamber connected to the discharge circuit for energizing the gas mixture;
a resonator including the discharge chamber and a line-narrowing and/or selection module for generating a narrow band laser beam; and
a spectrometer including a confocal Fabry-Perot interferometric device for monitoring one or more spectral parameters of the laser beam with high precision.

20. The laser system of claim 19, the spectrometer further comprising a photoelectric detector of an interferometer fringe image.

21. The laser system of claim 20, the confocal Fabry-Perot interferometer being disposed in a sealed and temperature-stabilized housing including windows through which the narrow band laser beam enters and exits the housing and interacts with the interferometer.

22. The laser system of claim 21, the spectrometer further comprising a reduction telescope for reducing the narrow band laser beam.

23. The spectrometer of claim 22, the reduction of the reduction telescope being at least substantially three times.

24. The laser system of claim 22, the spectrometer further comprising a diffusor to homogenizer the narrow band laser beam.

25. The laser system of claim 24, the spectrometer further comprising imaging optics for bringing the incident beam to focus at approximately a center of the interferometer.

26. The laser system of claim 25, the spectrometer further comprising interferometer fringe imaging optics.

27. The laser system of claim 21, the spectrometer further comprising a diffusor to homogenizer the narrow band laser beam.

28. The laser system of claim 21, the spectrometer further comprising imaging optics for bringing the incident beam to focus at approximately a center of the interferometer.

29. The laser system of claim 21, the spectrometer further comprising interferometer fringe imaging optics.

30. The laser system of claim 21, the interferometer housing being vacuum sealed.

31. The laser system of claim 21, the interferometer including a fixed interferometer spacer comprising a thermally-stable material.

32. The laser system of claim 31, the material being selected from the group consisting of ZEODUR, Cer Vit, and ULI.

33. The laser system of claim 21, further comprising a processor for receiving spectrometric signals from the spectrometer and initiating adjustments of one or more optical components in a feedback loop for wavelength stabilization of the lithography laser beam.

34. The spectrometer of claim 21, the interferometer including a piezoelectric spacer that can be tuned for operation of the interferometer in scanning mode.

35. The spectrometer of claim 21, the confocal Fabry-Perot interferometer being mounted within the housing, the pressure inside of the housing being adjustable for operation in scanning mode.

36. The spectrometer of claim 35, the interferometer including a fixed interferometer spacer comprising a thermally-stable material.

37. The spectrometer of claim 36, the material being selected from the group consisting of ZEODUR, Cer Vit, and ULI.

38. The spectrometer of claim 35, the interferometer including a piezoelectric spacer that can be tuned for operation of the interferometer in scanning mode.

39. The spectrometer of claim 20, the photoelectric detector being a detector array.

40. The spectrometer of claim 39, the detector array being a linear photodetector array.

41. The spectrometer of claim 20, the photoelectric detector comprising a diaphragm.

42. The spectrometer of claim 41, the diaphragm being an iris.

43. The spectrometer of claim 41, the photodetector including a single photodiode.

44. The spectrometer of claim 41, further comprising a processor for receiving spectrometric signals from the spectrometer and initiating adjustments of one or more optical components in feedback loop for wavelength stabilization of the lithography laser beam.

45. The spectrometer of claim 19, further comprising a processor for receiving spectrometric signals from the spectrometer and initiating adjustments of one or more optical components in feedback loop for wavelength stabilization of the lithography laser beam.
